(19) United States
(12) Patent Application Publication
(10) Pub. No.: US 2018/0117665 A1
(43) Pub. Date: May 3, 2018

(54) BLANK FORMING DEVICE USING ELECTRIC DIRECT HEATING AND METHOD OF MANUFACTURING A BLANK

(71) Applicants: Hyundai Motor Company, Seoul (KR); Kia Motors Corporation, Seoul (KR)

(72) Inventors: Jae Ryeon Hwang, Ulsan (KR); ByungHun Kim, Ulsan (KR)

(21) Appl. No.: 15/795,505

(22) Filed: Oct. 27, 2017

Related U.S. Application Data
(62) Division of application No. 14/278,571, filed on May 15, 2014, now abandoned.

(30) Foreign Application Priority Data
Sep. 4, 2013 (KR) 10-2013-0106121

(51) Int. Cl. B21J 1/06; B23K 11/30; H05B 3/02; B23K 11/00; H05B 3/03

(52) U.S. Cl. CPC B21J 1/06; B23K 11/3018; B23K 2201/006; B23K 11/0026; H05B 3/03; H05B 3/023

(57) ABSTRACT

A method of manufacturing a blank which uses direct electric heating includes: pressing electrodes on both sides of the blank and heating the blank by applying current to the blank; hot-forming the heated blank; trimming the formed blank; and loading the trimmed blank. An apparatus for manufacturing the blank includes a pair of first electrode units on both surfaces of a side of the blank to press the surfaces, a pair of second electrode units on both surfaces of the other side of the blank, a pressing unit pressing the first electrode units or the second electrode units on the blank, a cooler cooling portions around the first electrode units or the second electrode units, and a power supply control unit heating the blank up to a predetermined temperature.

### CROSS-REFERENCE TO RELATED APPLICATION

This application claims under 35 U.S.C. § 119(a) priority to and the benefit of Korean Patent Application No. 10-2013-0106121 filed in the Korean Intellectual Property Office on Sep. 4, 2013, the entire contents of which are incorporated herein by reference.

### BACKGROUND

### (a) Field of the Invention

The present invention relates to an apparatus for forming a blank for a car body that heats the blank by applying electricity directly to the blank and uses direct electric heating for forming it with a mold, and a method of manufacturing a blank with the apparatus.

### (b) Description of the Related Art

With the need of high fuel efficiency and light weight of vehicles, the strength of parts of the vehicles has been continuously increased.

In particular, some parts require high strength and other parts require high shock resistance for their structural characteristics.

When parts of vehicles which have different strengths are manufactured in the related art, the parts that require high strength generally are made of heat treatment-hardened steel plates, and the parts that require relatively low strength generally are made of common steel plate, and then vehicles are manufactured by welding the parts.

When a blank (steel plate) is heated by a heating furnace, a space for the heating furnace is needed, it is not easy to heat a portion of a blank with the heating furnace, and the maintenance cost for managing the heating furnace is high. The above information disclosed in this Background section is only for enhancement of understanding of the background of the invention and therefore it may contain information that does not form the prior art that is already known in this country to a person of ordinary skill in the art.

### SUMMARY

The present invention provides a method of manufacturing a blank which saves space normally dedicated to a heating furnace, easily heats a portion of a blank, and uses direct electric heating that reduces maintenance costs and improves productivity.

An exemplary embodiment of the present invention provides a method of manufacturing a blank which uses direct electric heating and includes: pressing electrodes on both sides of the blank and heating the blank by applying current to the blank; hot-forming the heated blank to produce a formed blank; trimming the formed blank; and loading the trimmed blank.

The electrodes may be pressed on the blank to heat a predetermined section of the blank.

Another embodiment of the present invention provides a method of manufacturing a blank which uses direct electric heating and includes: cold-forming the blank with a mold to produce a formed blank; trimming the formed blank; pressing electrodes on both sides of the formed blank and heating the blank by applying current to the blank; cooling the mold; and loading the formed and heated blank.

The electrodes may be pressed on the formed blank to heat a predetermined section of the formed blank.

The electrodes may have a shape corresponding to the shape of the formed blank.

Yet another embodiment of the present invention provides an apparatus for manufacturing a blank which uses direct electric heating and includes: a pair of first electrode units disposed on both surfaces of a side of the blank to press the surfaces; a pair of second electrode units disposed on both surfaces of the other side of the blank; a pressing unit pressing the first electrode units or the second electrode units on the blank; a cooler cooling the portions around the first electrode units or the second electrode units; and a power supply control unit heating the blank up to a predetermined temperature by supplying predetermined level of power to the first electrode units or the second electrode units for a predetermined time.

The power supply control unit may include a timer controller that controls a time for which power is supplied and a transformer that increases voltage.

The apparatus may include a moving part that moves the first electrode units or the second electrode units.

The first electrode units or the second electrode units may be formed to fit to the shape of the blank.

According to the present invention for achieving the objects, it is possible to save a space for a heating furnace, easily heat a portion of a blank, save maintenance cost, and improve productivity.

### BRIEF DESCRIPTION OF THE DRAWINGS

FIG. 1 is a schematic view of an apparatus for manufacturing a blank which uses direct electric heating according to an exemplary embodiment of the present invention.

FIG. 2 is a schematic diagram of an apparatus for manufacturing a blank which uses direct electric heating according to an exemplary embodiment of the present invention.

FIG. 3 is a perspective view showing a non-formed blank that is heated by the apparatus of FIG. 2.

FIG. 4 is a perspective view showing a formed blank that is heated by the apparatus of FIG. 2.

FIG. 5 is a perspective view showing a portion of a non-formed blank that is heated by the apparatus of FIG. 2.

FIG. 6 is a perspective view showing a portion of a formed blank that is heated by the apparatus of FIG. 2.

FIG. 7 is an enlarged perspective view showing a portion of a formed blank that is heated by the apparatus of FIG. 2.

FIG. 8 is a flowchart illustrating a method of manufacturing a blank which heats and then forms a blank according to an exemplary embodiment of the present invention.

FIG. 9 is a flowchart illustrating a method of manufacturing a blank which forms and then heats a blank according to an exemplary embodiment of the present invention.

### DETAILED DESCRIPTION OF THE EMBODIMENTS

An exemplary embodiment of the present invention will hereinafter be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

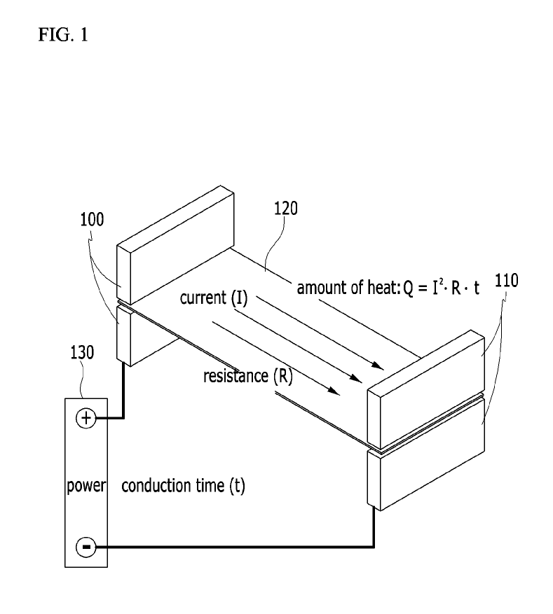

FIG. 1 is a schematic view of an apparatus for manufacturing a blank which uses direct electric heating according to an exemplary embodiment of the present invention.

Referring to FIG. 1, an apparatus for manufacturing a blank includes a blank 120, a first electrode unit 100, a second electrode unit 110, and a power supply 130.

The first electrode unit 100 includes a top electrode and a bottom electrode, in which the top electrode is in contact with the top of one end of the blank 120 and the bottom electrode is in contact with the bottom of the end of the blank 120, such that the top and the bottom of the blank 120 can be pressed.

The second electrode unit 110 includes a top electrode and a bottom electrode, in which the top electrode is in contact with the top of the other end of the blank 120, and the bottom electrode is in contact with the bottom of the end of the blank 120, such that the top and the bottom of the blank 120 can be pressed.

The blank 120 is heated within a predetermined range of temperature by applying electricity to the first electrode unit 110, the blank 120, and the second electrode unit 110. In particular, the blank 120 is heated by virtue of the electric energy flowing through it.

In an exemplary embodiment of the present invention, the blank 120 may be heated within approximately ten seconds by supplying electricity, and may be heated up to 950° C. Compared with the existing heating furnaces, space normally dedicated to a heating furnace is saved, and maintenance costs may be reduced, because it is not necessary to keep operating the equipment.

Further, there are advantages of being able to reduce the heating time, easily heat a portion of a blank, and easily control the temperature.

According to one example, the size of the blank may be 300 mm×300 mm, a desired heating temperature may be 1000° C., heating time may be within four seconds, and the required current may be 35 kA, with the power being set at 100 kw. Further, the pressing force applied to the blank 120 by the first electrode unit 100 and the second electrode unit 110 may be about 100 kgf/cm², a pneumatic cylinder with a diameter of about 28 mm is needed, the supplied air pressure may be 8 kgf/cm², and the width and length of the electrodes may be 10 mm and 300 mm, respectively. Assuming that the conduction time is six seconds, the entire cooling performance may be 1.1 kw (935 kcal/h).

Although the cost for manufacturing a mold may increase when manufacturing a partial mold for a blank, using a common heating furnace, only a portion of a blank is heated by electricity in an exemplary embodiment of the present invention, such that it is possible to reduce the cost for manufacturing a mold, save space, and use the apparatus for various processes.

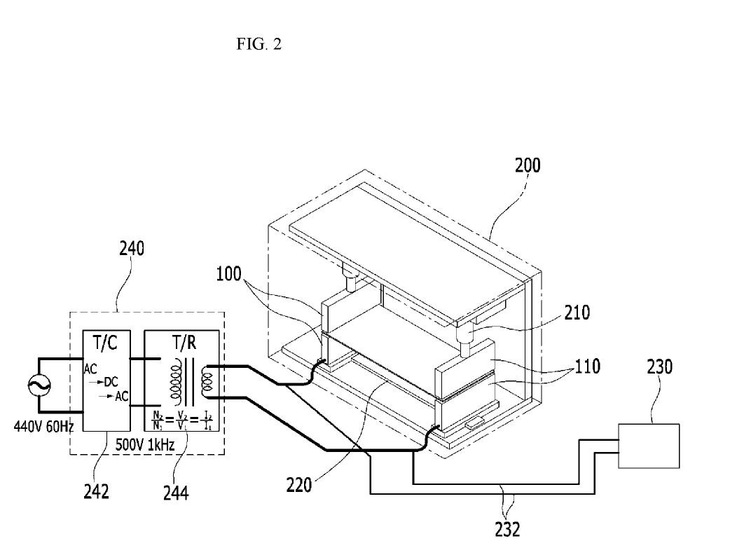

FIG. 2 is a schematic diagram of an apparatus for manufacturing a blank which uses direct electric heating according to an exemplary embodiment of the present invention.

Referring to FIG. 2, an apparatus for manufacturing a blank includes a blank 120, a first electrode unit 100, a second electrode unit 110, a fence 200, a pressing unit 210, a cooler 230, cooing lines 232, a linear guide 220, and a power supply control unit 240, in which the power supply control unit 240 includes a timer controller 242 and a transformer 244.

The linear guide 220, which is a moving part, moves the first electrode unit 100 and the second electrode unit 110 in the longitudinal direction of the blank 120, and the pressing unit 210 presses the electrodes of the first electrode unit 100 or the second electrode unit 110 onto the blank 120.

Cooling fluid circulates through the cooling lines 232 connected with the cooler 230, such that it can protect the first electrode, the second electrode, and the peripheral heated parts.

The power supply control unit 240 converts AC and DC, increases voltage, controls the time to supply power and the time for which power is supplied, and stably supplies power to the first electrode unit 100 or the second electrode unit 110.

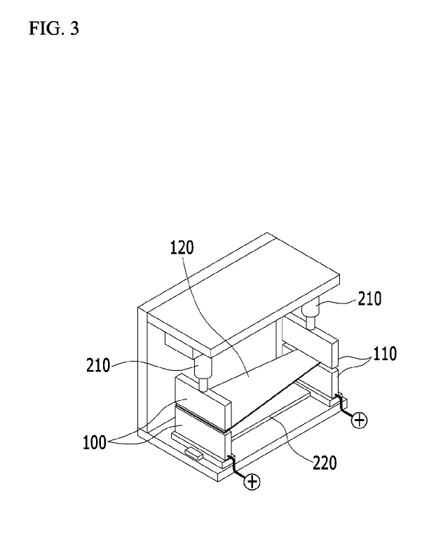

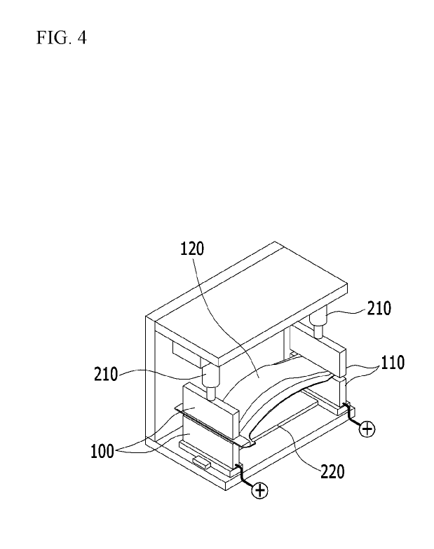

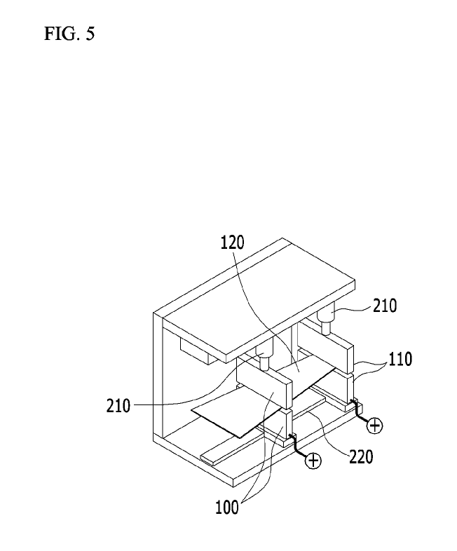

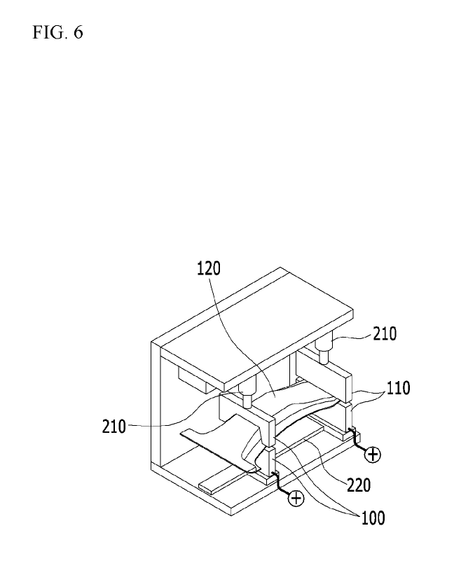

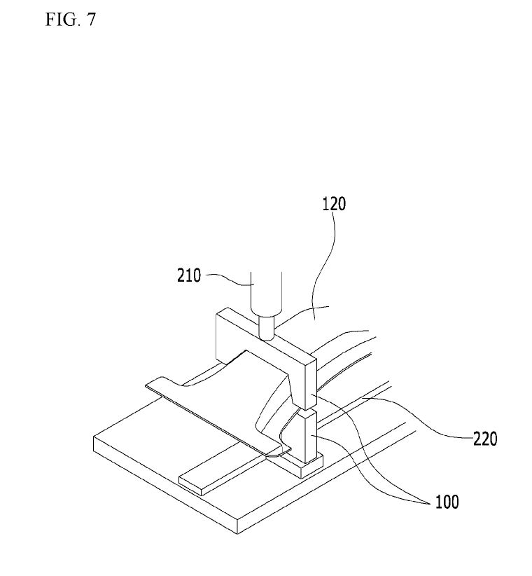

FIG. 3 is a perspective view showing that a non-formed blank is heated by the apparatus, FIG. 4 is a perspective view showing that a formed blank is heated by the apparatus, FIG. 5 is a perspective view showing that a portion of a non-formed blank is heated by the apparatus, FIG. 6 is a perspective view showing that a portion of a formed blank is heated by the apparatus, and FIG. 7 is an enlarged perspective view showing that a portion of a formed blank is heated by the apparatus. For example, the apparatus as described above and depicted in FIG. 2 can be used to heat the formed and non-formed blanks depicted in FIGS. 3-7.

Referring to FIG. 3, a flat non-formed blank 120 is heated by applying electricity to the entire blank 120. Thereafter, the heated blank 120 is formed.

Referring to FIG. 4, a completely formed blank 120 is heated by applying electricity to the entire area of the blank 120. Thereafter, the formed and heated blank 120 is cooled.

Referring to FIG. 5, a flat non-formed blank 120 is heated by applying electricity to a portion of the blank 120. Thereafter, the heated blank 120 is formed.

Referring to FIG. 6, a completely formed blank 120 is heated by applying electricity to a portion of the blank 120. Thereafter, the formed and heated blank 120 is cooled.

Referring to FIG. 7, the first electrode unit 100 is pressed on the top and the bottom of the completely formed blank 120, and the portions of the first electrode unit 100 which are in contact with the blank 120 are curved to fit to the shape of the formed blank 120. Accordingly, the first electrode unit 100 effectively transmits power to the blank 120.

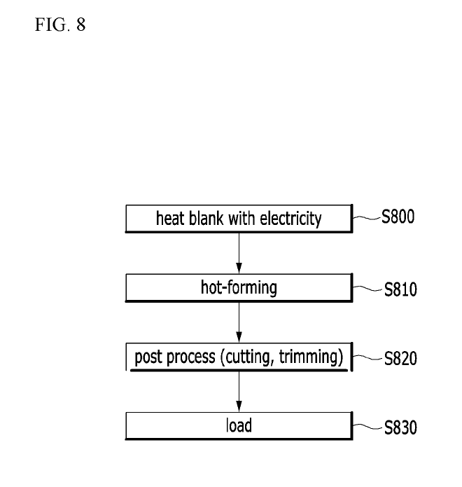

FIG. 8 is a flowchart illustrating a method of manufacturing a blank which heats and then forms a blank according to an exemplary embodiment of the present invention.

Referring to FIG. 1, the blank 120 is heated by power supplied through the first electrode unit 100 and the second electrode unit 110 in S800. The heated blank is put into a mold and formed therein in S810.

A post process is performed by cutting and trimming the edge of the formed blank 120 in S820 and the completed product is loaded, for example, by a robot in S830.

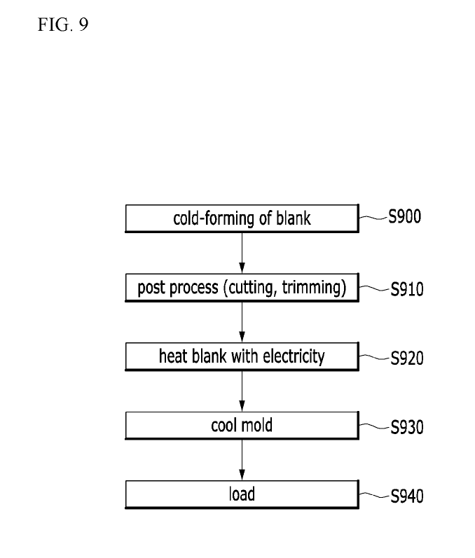

FIG. 9 is a flowchart illustrating a method of manufacturing a blank which forms and then heats a blank according to an exemplary embodiment of the present invention.

Referring to FIG. 9, the blank 120 is cold-formed at a room temperature by a mold or a forming machine in S900. The formed blank 120 is finished through a post process such as cutting or trimming in S910.

The finished blank 120 is heated by electricity in S920, the mold or the heated blank 120 is cooled in S930, and the completed blank 120 is loaded, for example, by a robot in S940.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of manufacturing a blank which uses direct electric heating, the method comprising:
pressing electrodes on both sides of the blank and heating the blank by applying current to the blank;
hot-forming the heated blank to produce a formed blank;
trimming the formed blank; and
loading the trimmed blank.

2. The method of claim 1, wherein the electrodes are pressed on the blank to heat a predetermined section of the blank.

3. A method of manufacturing a blank which uses direct electric heating, the method comprising:
cold-forming the blank with a mold to produce a formed blank;
trimming the formed blank;
pressing electrodes on both sides of the formed blank and heating the formed blank by applying current to the formed blank;
cooling the mold; and
loading the formed and heated blank.

4. The method of claim 3, wherein the electrodes are pressed on the formed blank to heat a predetermined section of the formed blank.

5. The method of claim 4, wherein the electrodes have a shape corresponding to the shape of the formed blank.

6-9. (canceled)
